(19) United States
(12) Patent Application Publication
(10) Pub. No.: US 2015/0326784 A1
(43) Pub. Date: Nov. 12, 2015

(54) IMAGE CAPTURING CONTROL METHOD AND IMAGE PICKUP APPARATUS

(71) Applicant: CANON KABUSHIKI KAISHA, Tokyo (JP)

(72) Inventor: Tadashi Hayashi, Yokohama-shi (JP)

(21) Appl. No.: 14/705,297

(22) Filed: May 6, 2015

(30) Foreign Application Priority Data
May 9, 2014 (JP) 2014-097507

(51) Int. Cl. H04N 5/232

(52) U.S. Cl. CPC H04N 5/23245

(57) ABSTRACT

An image of a work is formed such that the image moves in a fixed direction across an image sensing area of an image sensor. The image of the work is captured by the image sensor when it is at an image capture position, and image data thereof is output in a predetermined output format. The image sensor has an extraction area having a small image size or a small pixel density and is located on a side of an image sensing area of the image sensor from which the moving object enters the image sensing area. When it is detected in this extraction area that the object has arrived at a preliminary detection position located before the image capture position, the mode of the image sensor is switched such that image data is output in the output format, and the image data is output in this output format.

### BACKGROUND

1. Technical Field

The present disclosure relates to an image capturing control method and an image pickup apparatus, and more particularly, to a technique of controlling a process of forming an image of a moving object such that the image of the moving object moves in a fixed direction in an image sensing area of an image sensor, capturing the image of the moving object at an image capture position using the image sensor, and outputting image data of the captured image in a predetermined output format from the image sensor.

2. Description of the Related Art

Conventionally, it is known to use a transport unit such as a robot, a belt conveyor, or the like in a production line or the like to transport a word such as a product or a part to a work position or an inspection position where to assemble or inspect the work. In many cases, the work, which is an object of interest, is in an arbitrary posture while being transported. In general, after the work arrives at the work position, the posture or the phase of the object is measured and the posture or the phase is corrected appropriately using a robot arm or hand, and then processing or an assembling operation is started.

Also in the case where inspection is performed, the inspection is generally started after an object arrives at an inspection station dedicated to the inspection. In the case of an appearance inspection (optical inspection or image inspection), measurement or inspection is performed using image data acquired by capturing an image of an object using a camera. The capturing of the image of the object for the measurement or the inspection is generally performed after the movement of the object is temporarily stopped. However, in this method, temporarily stopping the transport apparatus causes an additional time to be needed to accelerate and decelerate the transport apparatus, which brings about a demerit that an increase occurs in inspection time or measurement time.

In another proposed technique, an image of an object being transported is captured by a camera without stopping the object, and assembling, measurement, or inspection of the object is performed based on the captured image data. In this technique, it is necessary to detect that the object is at a position suitable for capturing the image of the object. To achieve the above requirement, for example, a photosensor or the like is disposed separately from the camera. When an object is detected by the photosensor, the moving distance of the object is measured or predicted, and an image of the object is captured when a particular time period has elapsed since the object was detected by the photosensor.

It is also known to install a video camera in addition to a still camera for measurement. The video camera has an image sensing area including an image sensing area of a still camera and used to grasp the motion of an object before an image of the object is captured by the still camera (see, for example, Japanese Patent Laid-Open No. 2010-177893). In this method, when entering of the object into an image sensing area is detected via image processing on the image captured by the video camera, a release signal is input to the still camera for measurement to make the still camera start capturing the image.

However, in the above-described method, to detect entering of an object into the image sensing area, it is necessary to install the dedicated optical sensor, and furthermore it is necessary to provide a measurement unit to measure the moving distance of the object. Furthermore, when the size of the object is not constant, a difference in the size of the object may cause an error to occur in terms of the image capture position. In a case where the position of the object is determined based on the prediction thereof, if a change occurs in speed of the transport apparatus such as the robot, the belt conveyor, or the like, an error may occur in terms of the image capture position.

In the above-described technique disclosed in Japanese Patent Laid-Open No. 2010-177893, the video camera is used to detect the moving object and thus the position of the object is determined without using prediction, which makes it possible to control the image capture position at a substantially fixed position. However, it is necessary to additionally install the video camera which is not necessary in the measurement or the inspection, which results in an increase in cost and installation space. Furthermore, a complicated operation is necessary to adjust relative positions between the still camera and the video camera. Furthermore, it is necessary to provide a high-precision and high-speed synchronization system and an image processing system to detect the object. Furthermore, in case where to perform inspection properly, it is necessary to capture an image of an object at a particular position in an angle of view of the still camera, more precise adjustment of the relative camera positions and more precise synchronization are necessary, which makes it difficult, in practice, to achieve a simple system at acceptable low cost.

In view of the above situation, the present invention provides a technique of automatically capturing an image of a work given as a moving object at an optimum image capture position at a high speed and with high reliability without stopping the motion of the work and without needing an additional measurement apparatus other than the image pickup apparatus.

### SUMMARY

In an aspect, the disclosure provides an image capturing control method for capturing an image of a moving object using an image sensor and outputting image data in an output format with a predetermined image size and pixel density from the image sensor, the method including setting, by a control apparatus, an output mode of the image sensor to a first output mode in which image data of an extraction area is output wherein the extraction area has a smaller image size or a smaller pixel density than the image size or the pixel density in the output format and wherein the extraction area is located on such a side of an image sensing area of the image sensor from which the image of the moving object is to approach the image sensing area, performing a moving object detection process by the control apparatus to detect whether a position of the moving object has reached a preliminary detection position before a predetermined image capture position based on a pixel value of the image data output in a state in which the output mode of the image sensor is set in the first output mode, and in a case where, in the moving object detection process, it is detected that the position of the moving object whose image being captured has reached the preliminary detection position before the image capture position, setting, by the control apparatus, the output mode of the image sensor to a second output mode in which image data captured by the image sensor is output in the output format, wherein the image data of the moving object captured at the image capture position by the image sensor is output in the second output mode from the image sensor.

In another aspect, the disclosure provides an image pickup apparatus including a control apparatus configured to control a process of capturing an image of a moving object using an image sensor and outputting image data in an output format with a predetermined image size and pixel density from the image sensor, the control apparatus being configured to set an output mode of the image sensor to a first output mode in which image data of an extraction area is output wherein the extraction area has a smaller image size or a smaller pixel density than the image size or the pixel density of the output format and wherein the extraction area is located on such a side of an image sensing area of the image sensor from which the image of the moving object is to approach the image sensing area, detect whether the position of the moving object has reached a preliminary detection position before a predetermined image capture position based on a pixel value of the image data output in a state in which the output mode of the image sensor is set in the first output mode, and in a case where it is detected that the position of the moving object has reached the preliminary detection position before the image capture position, set the output mode of the image sensor to a second output mode in which image data captured by the image sensor is output in the output format, wherein the image data of the image of the moving object captured at the image capture position by the image sensor is output in the second output mode from the image sensor.

Further features of the present invention will become apparent from the following description of exemplary embodiments with reference to the attached drawings.

### BRIEF DESCRIPTION OF THE DRAWINGS

FIG. 1 is a block diagram illustrating a configuration of an apparatus operable by an image capturing control method according to a first embodiment.

FIG. 2 is a flow chart illustrating an image capture control procedure according to the first embodiment.

FIGS. 3A to 3C are diagrams illustrating examples of pixel selection areas according to the first embodiment.

FIGS. 4A to 4C are diagrams illustrating output states of an image sensor during a process of transporting a work according to the first embodiment.

FIGS. 5A and 5B are diagrams illustrating examples of images captured using regular reflection according to the first embodiment.

FIG. 6 is a flow chart illustrating an image capture control procedure according to a second embodiment.

FIGS. 7A to 7D are diagrams illustrating operations of generating difference images according to the second embodiment.

FIG. 8 is a diagram illustrating an example of a manner in which pixels are selected and outputs are controlled according to a third embodiment.

FIG. 9 is a diagram illustrating another example of a manner in which pixels are selected and outputs are controlled according to the third embodiment.

FIG. 10 is a diagram illustrating an image extracted as a result a process of selecting pixels and controlling outputting according to the manner illustrated in FIG. 9.

FIGS. 11A and 11B are diagrams illustrating still other examples of manners in which pixels are selected and outputs are controlled according to the third embodiment.

FIG. 12 is a diagram illustrating an example of a manner of selecting pixels using an image sensor capable of extracting image data only in units of lines of pixels according to the third embodiment.

### DESCRIPTION OF THE EMBODIMENTS

Embodiments of the invention are described in detail below with reference to accompanying drawings. In the following description, by way of example, the embodiments are applied to a robot apparatus or a production system in which a work, which is an example of an object, is transported by a robot arm, and an image of the work is captured at a predetermined image capture position by a camera without stopping the motion of the work during the transportation.

### First Embodiment

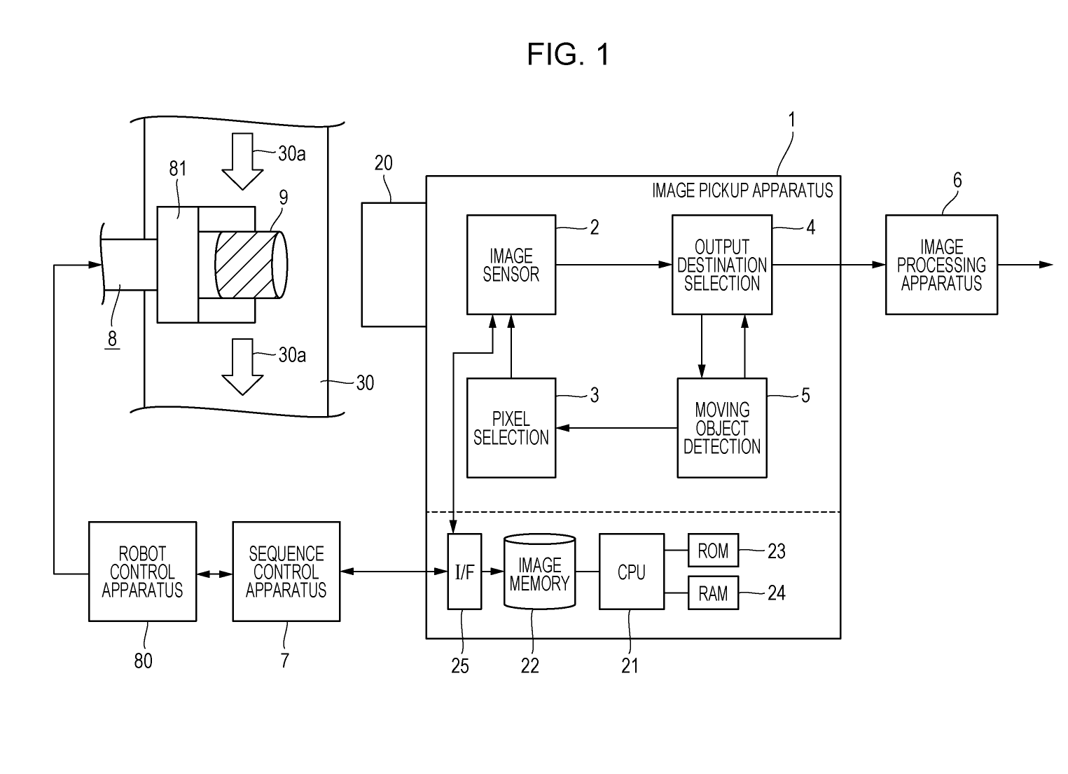

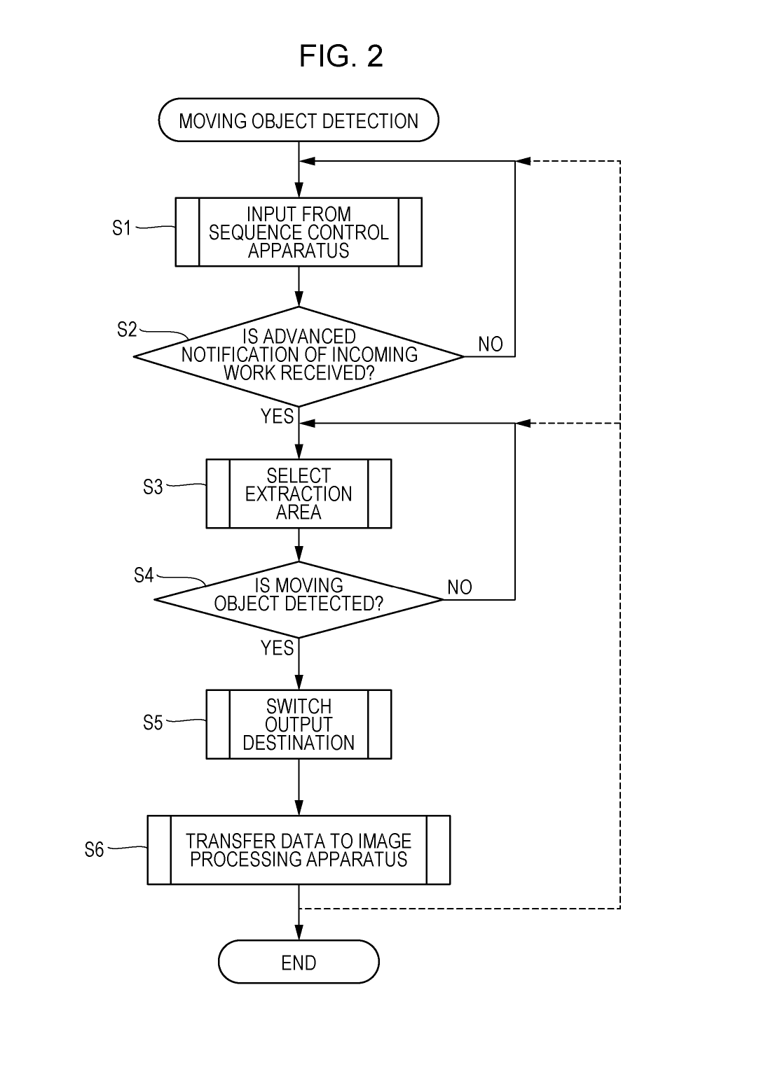

FIG. 1 illustrates an outline of a configuration of a robot apparatus (or a production system using a robot) using an image pickup apparatus according to a first embodiment. FIG. 2 is a flow chart illustrating an image capture control flow according to the present embodiment.

In FIG. 1, a work 9, which is a moving object whose image is captured according to the present embodiment, is held by a robot hand 81 located at an end of a robot arm 8 and is transported in a transport space 30 as represented by arrows 30a. The transport space 30 is, for example, a transport path via which the work 9 is transported by the robot apparatus (or the production system using the robot) to a next work position or an inspection position. An image of the work 9 is captured by an image pickup apparatus 1 when the work 9 is a predetermined image capture position in the transport space 30 while the work 9 is being transported.

The image of the work 9 captured by the image pickup apparatus 1 is subjected to image processing performed an image processing apparatus 6 and is used in controlling a posture (or a phase) of the work 9 or in product inspection. Image data of the work 9 captured by the image pickup apparatus 1 is output in an output format with a predetermined image size and a pixel density to the image processing apparatus 6.

The image processing apparatus 6 performs predetermined image processing necessary in controlling the posture of the work 9 or in production inspection (quality judgment). The details of the image processing are not directly related to subject matters of the present embodiment, and thus a further description thereof is omitted. Detection information as to, for example, the posture (or the phase) acquired via the image processing performed by the image processing apparatus 6 is sent from the image processing apparatus 6 to, for example, a sequence control apparatus 7 that controls general operations of the robot apparatus (or the production system) including the image pickup apparatus 1.

Based on the received detection information of the posture (or the phase), the sequence control apparatus 7 controls the robot arm 8 via the robot control apparatus 80 until the robot arm 8 arrives at, for example, the work position or the inspection position in a downstream area such that the posture (or the phase) of the work 9 is brought into a state proper for a next step in a production process such as assembling, processing, or the like. In this process, the sequence control apparatus 7 may control the posture (or the phase), for example, by feeding a result of the measurement performed by the image processing apparatus 6 back to the robot control apparatus 80.

In the production system using the image pickup apparatus 1 illustrated in FIG. 1, as described above, it is possible to perform a particular production process or an inspection process on the work 9 based on the image processing performed by the image processing apparatus 6.

The sequence control apparatus 7 sends a control signal to the image pickup apparatus 1 before the work 9 passes through the image sensing area of the work 9 thereby to cause the image pickup apparatus 1 to go into a first mode (a state in which to wait for the work 9 to pass through) in which the moving object is to be detected.

The image pickup apparatus 1 includes an imaging optical system 20 disposed so as to face the transport space 30, and an image sensor 2 disposed on an optical axis of the imaging optical system 20. By configuring the apparatuses in the above-described manner, the image of the moving object is formed on an image sensing area of the image sensor 2 such that the image moves in a particular direction in the image sensing area, and the image of the moving object is captured by the image sensor 2 when the image is at a predetermined image capture position. Parameters of the imaging optical system 20 as to a magnification ratio and a distance to an object are selected (or adjusted) in advance such that the whole (or a particular part) of the work 9 is captured within an image sensing area of the image sensor 2.

The image capture position, at which the image of the work 9 is captured and data thereof is sent to the image processing apparatus 6, is set such that at least the whole (or a particular part) of the moving object, i.e., the work 9 is captured within the image sensing area of the image sensor 2. In the following description, the term “image capture position” of the work 9 is used to describe the “position”, in the image sensing area, of the image of the work 9, and an explicit description that the “position” indicates the image position” is omitted when no confusion occurs.

A moving object detection unit 5 described later detects whether the work 9 (the image of the work 9) has arrived at a particular preliminary detection position before the optimum image capture position in the image sensing area of the image sensor 2.

In FIG. 1, in a block representing the image pickup apparatus 1, all sub-blocks located above a broken line except for the image sensor 2 are functional blocks realized by a control operation of a control system located below the broken line. In FIG. 1, these functional blocks are a pixel selection unit 3, an output destination selection unit 4, and a moving object detection unit 5. Of these functional blocks, the output destination selection unit 4 operates to select whether the image data output from the image sensor 2 is sent to the external image processing apparatus 6 or the moving object detection unit 5.

When the moving object detection unit 5 receives the image data output from the image sensor 2, the moving object detection unit 5 detects a particular feature part of the work 9 using a method described later, and performs a detection as to whether the work 9 has arrived at the preliminary detection position before the predetermined image capture position in the transport space 30. Herein the “preliminary detection position before the image capture position” is set to handle a delay that may occur in starting outputting the image data to the image processing apparatus 6 after the moving object is detected by the moving object detection unit 5. The delay may be caused by a circuit operation delay or a processing delay and it may be as large as at least one to several clock periods. That is, the preliminary detection position before the image capture position is properly set taking into account the circuit operation delay, the processing delay, or the like such that when outputting of image data to the image processing apparatus 6 is started immediately in response to the moving object detection unit 5 detecting the moving object, the image position of the work 9 in the image data is correctly at the image capture position.

The pixel selection unit 3 controls the image sensor 2 such that a particular pixel is selected from pixels of the image sensor 2 and data output from the selected pixel is sent to the output destination selection unit 4 located following the pixel selection unit 3. Until the arrival of the work 9 at the preliminary detection position before the predetermined image capture position is detected, the pixel selection unit 3 controls the image sensor 2 such that only pixel data of pixels in a particular area, for example, a small central arear of the image sensor 2 is output to the moving object detection unit 5. Using the image of this small area, the moving object detection unit 5 performs the detection of the arrival of the work 9 at the preliminary detection position before the predetermined image capture position in the transport space 30.

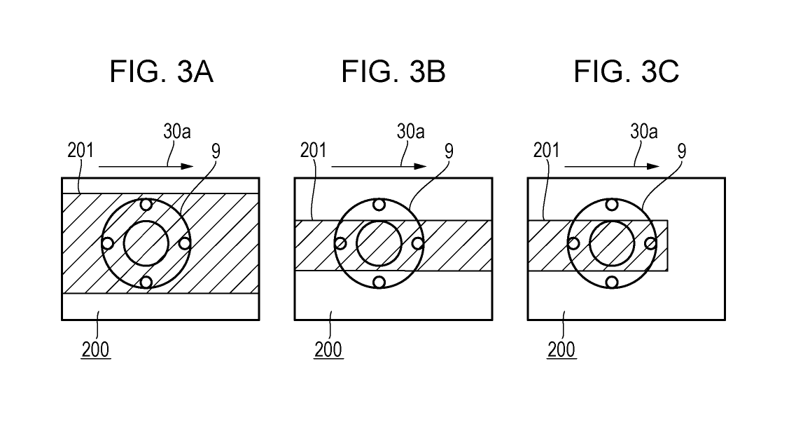

Hereinafter, a term “extraction area” is used to describe the above-described small area including the small number of pixels whose data is sent from the image sensor 2 to the moving object detection unit 5 until the moving object detection unit 5 detects the arrival of the work 9 at the preliminary detection position before the predetermined image capture position. In FIGS. 3A to 3D described later and elsewhere, the extraction area denoted by reference numeral 201.

Note that when data of pixels in this extraction area (201) is sent to the moving object detection unit 5, data does not necessarily need to be sent from pixels at consecutive spatial locations. For example, the extraction area (201) may include a set of pixels located at every two or several pixels in the image sensor 2 such that low-resolution image data is sent to the moving object detection unit 5. Hereinafter, the term “extraction area” is used to generically describe extraction areas including the extraction area (201) that is set so as to include such a set of low-resolution pixels to transmit image data for use in the moving object detection to the moving object detection unit 5.

When the moving object detection unit 5 detects the arrival of the work 9 at the preliminary detection position before the predetermined image capture position, the pixel selection unit 3 switches the readout area of the image sensor 2 such that the image data is output in an output format having an image size and a pixel density necessary in the image processing performed by the image processing apparatus 6. Furthermore, in response to the moving object detection unit 5 detecting the arrival of the work 9 at the preliminary detection position before the predetermined image capture position, the output destination selection unit 4 switches the transmission path of the image data such that the image data captured by the image sensor 2 is sent to the image processing apparatus 6.

When the image data of the work 9 captured by the image sensor 2 is sent to the image processing apparatus 6 for use in the image processing on the image data, the output format of the image data is set so as to have an image size (the number of pixels in horizontal and vertical directions) in which the whole work 9 or at least a particular part of the work 9 to be measured or inspected falls within an angle of view. In this output format of the image data output to the image processing apparatus 6, the image data has a high pixel density (a high resolution) without being thinned (or slightly thinned). In the following description, it is assumed that the image data of the work 9 sent to the image processing apparatus 6 for use in the image processing performed by the image processing apparatus 6 has a size large enough and/or a resolution high enough for the image processing apparatus 6 to perform the image processing.

Thus, the image sensor 2 captures the image of the work 9 at the predetermined image capture position, and pixel data of the particular area of the image data with the image size necessary for the image processing apparatus 6 to perform the image processing is sent to the image processing apparatus 6.

The arrival of the work 9 at the preliminary detection position before the predetermined image capture position in the transport space 30 is detected by the moving object detection unit 5 using the pixel data in the extraction area (201) described above. Thus it is possible to make a high-speed detection of the arrival of the work 9 at the preliminary detection position before the predetermined image capture position while moving the work 9 in the transportation space 30 at a high speed without stopping the operation of the robot arm 8 to transport the work 9, which results in a reduction in calculation cost.

The functional blocks described above may be realized, for example, by hardware disposed in the area below the broken line in the image pickup apparatus 1 illustrated in FIG. 1. This hardware in the image pickup apparatus 1 includes, for example, a CPU 21 including a general-purpose microprocessor, graphic CPU (GPU), or the like, an image memory 22 including high-speed memory elements, a ROM 23, a RAM 24, an interface circuit 25, and the like. Each functional block described above is realized by the CPU 21 by executing a computer-readable program that describes a control procedure described later and that is stored, for example, in the ROM 23 thereby controlling various parts of the hardware.

For example, the pixel selection unit 3 is realized by the CPU 21 by controlling the output mode of the image sensor 2 via the interface circuit 25 so as to specify a particular area of the output pixel area of the image sensor 2. In this control operation, one of output modes of the image sensor 2 switched by the pixel selection unit 3 is a first output mode in which image data of the above-described extraction area 201 to be subjected to the detection by the moving object detection unit 5 is output. The other one of the output modes is a second output mode in which image data of the above-described extraction area 201 to be subjected to the image processing by the image processing apparatus 6 is output.

The extraction area 201 used in the first output mode has a smaller image size or smaller pixel density than the output format used to output image data to the image processing apparatus 6, and the extraction area 201 is set, as illustrated in FIGS. 3A to 3C, at a location on such a side of an image sensing area of the image sensor 2 from which the image of the moving object is to approach the image sensing area.

The moving object detection unit 5 is realized by the CPU 21 by executing software to analyze the image in the above-described extraction area (201) output from the image sensor 2. The image data output from the image sensor 2 is transferred at a high speed to the image memory 22 via data transfer hardware described below or the like, and the CPU 21 analyzes the image data on the image memory 22. In the present embodiment, it is assumed by way of example that the function of the moving object detection unit 5 is realized by the CPU 21 and the CPU 21 analyzes the image data on the image memory 22. However, for example, in a case where the CPU 21 and the image sensor 2 have an image stream processing function, the CPU 21 may directly analyze the image data of the extraction area (201) not via the image memory 22.

The interface circuit 25 includes, for example, a serial port or the like for communicating with the sequence control apparatus 7, and also includes data transfer hardware such as a multiplexer, a DMA controller, or the like to realize the output destination selection unit 4. The data transfer hardware of the interface circuit 25 is, to realize the function of the output destination selection unit 4, used to transfer captured image data from the image sensor 2 to the image memory 22 or to the image processing apparatus 6.

The image pickup apparatus 1 is described in further detail below focusing on its hardware.

In the present embodiment, it is assumed that the image sensor 2 has a resolution high enough to resolve features of the work 9. The image processing apparatus 6 performs predetermined image processing on the image data with a sufficiently high resolution output from the image pickup apparatus 1. The image processing may be performed using a known method although a description of details thereof is omitted here. A result of the image processing is sent, for example, to the sequence control apparatus 7 and is used in controlling the posture of the work 9 by the robot arm 8. Thus, it is possible to control the posture during the transportation to the without stopping the operation of the robot arm 8 to transport the work 9 at a high speed such that the controlling of the posture is complete before the work 9 arrives at the work position or the inspection position in a downstream area. The image processing by the image processing apparatus 6 may also be used in the inspection of the work 9. In this case, for example, the state of the work 9 is inspected and a judgment is made as to whether the work 9 is good or not by analyzing a feature part of the work 9 being in a state in which assembling is completely finished or half-finished.

The image sensor 2 may be a known image sensor device including a large number of elements arranged in a plane configured to output digital data for each pixel of an image formed on a sensor surface. In this type of sensor, in general, data is output in a raster scan mode. More specifically, pixel data of a two-dimensional image is first sequentially output in a horizontal direction (that is the two-dimensional image is scanned in the horizontal direction). After the scanning is complete over one horizontal line, then the scanning is performed for a vertically adjacent next horizontal line (horizontal lines are sequentially selected in a vertical direction (horizontally scanned)). The above operation is repeated until the hole image data has been scanned.

As for the image sensor used as the image sensor 2, for example, a charge coupled device (CCD) sensor may be employed. In recent years, a complementary metal oxide semiconductor (CMOS) sensor has also been used widely. Of these image sensors, the CCD sensor has a global shutter that allows it to expose all pixels simultaneously, and thus this type of CCD sensor is suitable for capturing an image of a moving object. On the other hand, the CMOS sensor generally has a rolling shutter and operates such that image data is output while shifting exposure timing every horizontal scanning. In both shutter operation methods described above, the shutter operation is achieved by controlling reading-out of the image data, that is, the shutter operation is performed electronically in both methods. When an image of a moving object is captured using an image sensor with a rolling shutter, shifting of exposure timing from one horizontal scanning line to another causes the shape of the image to be distorted from a real shape. Note that some CMOS sensor has a capability of temporarily storing data for each pixel. In this type of CMOS sensor, it is possible to achieve the global-shutter reading, and thus it is possible to obtain an output image of a moving object having no distortion.

Therefore, in the present embodiment, to properly deal with a moving object, as for a device used as the image sensor 2, it may be advantageous to select a CCD sensor with the basic global shutter functionality or a CMOS sensor of a type with the global shutter functionality. However, in a case where distortion of a shape does not result in a problem in the image processing performed by the image processing apparatus 6, a CMOS sensor with the ordinary rolling shutter function may be selected.

Referring to a flow chart illustrated in FIG. 2, an image capture control procedure according to the present embodiment is described below. The control procedure illustrated in FIG. 2 may be described, for example, in the form of a control program executable by the CPU 21 of the image pickup apparatus 1 and may be stored in the ROM 23 or the like.

In step S1 in FIG. 2, the CPU 21 waits for an input to be given from the sequence control apparatus 7. In this state, the image sensor 2 and the output destination selection unit 4 are controlled to be in an output-off state.

In step S2, the CPU 21 checks whether an input is given from the sequence control apparatus 7 and determines whether a notification indicating that a next work 9 is going to enter the image capture space of the image pickup apparatus 1 has been received. In the controlling by the sequence control apparatus 7 as to the operation of the robot arm 8 to transport the work 9, when the work 9 is going to pass through the image capture space of the image pickup apparatus 1, the sequence control apparatus 7 transmits an advanced notification in a predetermined signal format to the image pickup apparatus 1 to notify that the work 9 is going to pass through the image capture space of the image pickup apparatus 1. For example, in a case where many different types of work 9 are handled with in the production system, information as to the type, the size, and/or the like of the work 9 may be added as required to the advanced notification signal sent to the image pickup apparatus 1 or the image processing apparatus 6. If the advanced notification arrives in step S2, then the processing flow proceeds to step S3. If the advanced notification has not yet arrived, the processing flow returns to step S1 to wait for an input to be given from the sequence control apparatus 7.

In a case where the advanced notification is received in step S2, then in step S3, a pixel selection control operation using the pixel selection unit 3 is performed. More specifically, the CPU 21 accesses the image sensor 2 via the interface circuit 25 and switches the image sensor 2 to the first mode in which pixel data of the extraction area (201) for use in detecting a moving object is output, and enables the image sensor 2 to output pixel data. Furthermore, the CPU 21 controls the data transfer hardware of the interface circuit 25 providing the function of the output destination selection unit 4 such that the destination of the output from the image sensor 2 is switched so as to the image data is output to the moving object detection unit 5. In response, the pixel data of the extraction area (201) is sequentially transmitted to a particular memory space in the image memory 22, and the CPU 21 starts to execute the software functioning as the moving object detection unit 5 to analyze the image (as described later) to detect the position of the work 9. Note that in step S3, the image size and/or the pixel density of the extraction area (201) may be properly selected depending on the type and/or the shade of the work.

In step S4, it is determined whether the moving object detection unit 5 has detected the arrival of the work 9 at the preliminary detection position before the predetermined image capture position in front of the imaging optical system 20 of the image pickup apparatus 1. A detailed description will be given later as to specific examples of processes of detecting the moving object by image analysis by the moving object detection unit 5 realized, for example, by the CPU 21 by executing software.

In a case where it is determined that the moving object detection unit 5 has detected the arrival of the work 9 at the preliminary detection position before the predetermined image capture position of the image pickup apparatus 1, the processing flow proceeds to step S5. However, in a case where the arrival is not yet detected, the processing flow returns to step S3.

In the case where the arrival of the work 9 at the preliminary detection position before the predetermined image capture position of the image pickup apparatus 1 is detected and the processing flow proceeds to step S5, the mode of the image sensor 2 is switched to the second mode in which pixel data is output from the pixel region corresponding to the particular image size necessary in the image processing performed by the image processing apparatus 6. More specifically, in the second mode, for example, the output pixel area of the image sensor 2 is set so as to cover the image of the whole or the particular inspection part of the work 9. Furthermore, the data transfer hardware of the interface circuit 25 functioning as the output destination selection unit 4 is controlled such that the destination of the output of the image sensor 2 is switched to the image processing apparatus 6.

Next, in step S6, the image data of the pixel region corresponding to the particular image size necessary in the image processing is transmitted from the image sensor 2 to the image processing apparatus 6. In this transmission process, the image data is transmitted via the image memory 22 as a buffer area or directly from the image sensor 2 to the image processing apparatus 6 if the hardware allows it. In this way, the data of one frame of image with the large size of the work 9 (or the particular part thereof) or the high-resolution image thereof is output from the image sensor 2.

When the transmission of the image data of the work 9 captured by the image sensor 2 to the image processing apparatus 6 is complete, the processing flow returns to step S1. In step S1, the pixel selection unit 3 is switched to the state in which the processing flow waits for an input to be given from the sequence control apparatus 7, and the image sensor 2 and the output destination selection unit 4 are switched to the output-off state.

Next, referring to FIGS. 3A to 3C and other figures elsewhere, a description is given below as to examples of configurations of the extraction area 201 controlled by the pixel selection unit 3 such that image data in this extraction area 201 is output from the image sensor 2 to the moving object detection unit 5 for use in the detecting the object.

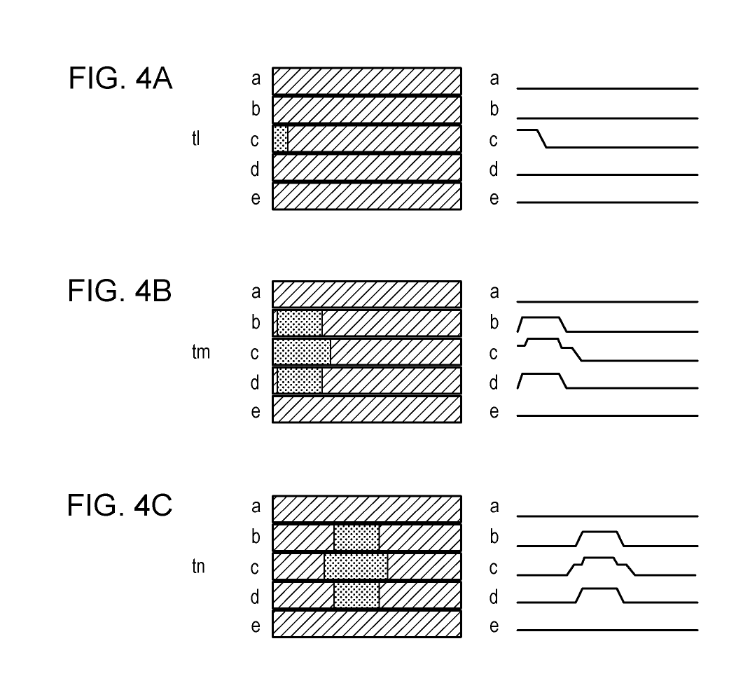

FIGS. 3A to 3C respectively illustrate examples of different manners in which the pixel selection unit 3 configures, via the pixel selection process, the extraction area 201 such that image data in this extraction area 201 is output from the image sensor 2 to the moving object detection unit 5 for use in the detecting the object. In FIGS. 3A to 3C (and also FIGS. 4A to 4C and other figures elsewhere), reference numeral 200 denotes an effective image sensing area (full angle of view) captured by the image sensor 2.

Furthermore, in FIGS. 3A to 3C, as in FIG. 1, an arrow 30a represents a transport direction in which the work 9 is transported by the robot arm 8. Although the work 9 is drawn so as to have, by way of example, a ring shape in these figures and other figures elsewhere, there is no particular restriction on the shape in the present embodiment. Furthermore, in these figures and other figures elsewhere, small circles corresponding to structures such as bolts, studs, projections, or the like are drawn at four locations equally spaced on the circumference of the work 9 in order simply to indicate the posture or the phase of the work 9, and these circles are not essential in the invention.

In each of FIGS. 3A to 3C, a hatched area represents the extraction area 201. FIG. 3A illustrates an example of the extraction area 201 that is used to extract an area through which the work 9 is predicted to pass. In this example, the extraction area 201 has a band shape extending in the moving direction of the work 9 and has a width (as defined in a vertical direction in FIG. 3A) nearly equal to the width (the diameter) of the work 9.

Note that the size of the work 9 and the size of the extraction area 201 in the image sensing area 200 are illustrated only as examples, and they may be appropriately changed depending on the distance to the object to be captured by the image pickup apparatus 1, the magnification ratio of the imaging optical system 20, and/or the like. This also applies to other examples described below.

In FIG. 3A, the extraction area 201 occupies a relatively large area of the image sensing area 200, and thus, to analyze the extraction area 201, the software of the moving object detection unit 5 needs to access data of relatively many pixels. In such a situation, it is not necessary to output data of all pixels in the whole extraction area 201 denoted by hashing, but the pixel data may be thinned out and resultant data may be output. Some types of devices used as the image sensor 2 have a mode in which thinned-out pixel data is output. Even in the case where the extraction area 201 is set so as to cover a relatively large area as with the case in the example illustrated in FIG. 3A, if the pixel data is output only for only the thinned-out data without outputting all pixel data in the extraction area 201 from the image sensor 22, it is possible to achieve a high image data transfer rate (a high frame rate). This also makes it possible to reduce a processing load imposed on the software of the moving object detection unit 5, and to improve the position detection period, and thus it becomes possible to accurately detect the arrival of the work at the image capture position optimum for the image processing.

In the case where the work 9 is detected as the moving object by the software functioning as the moving object detection unit 5, the purpose for the detection is to detect the arrival of the work 9 at the preliminary detection position before the predetermined image capture position at which an image of a particular part of the work 9 is to be captured for use in the image processing performed by the image processing apparatus 6. From this point of view, the output angle of view of the extraction area 201 does not necessarily need to cover the entire width of the work 9, but the extraction area 201 may be set so as to cover only a part of the width of the work 9 as in the example illustrated in FIG. 3B. In this case, however, the size of the extraction area 201 needs to be set so as to include sufficient pixels such that it is assured that the moving object detection unit 5 correctly detects the work 9 (the position of the work 9) using the pixel data of the extraction area 201.

In the case where the extraction area 201 is set as illustrated in FIG. 3B, it is possible to estimate the position of the work 9 if a leading end of the work 9 (an end at the right-hand side of the work 9 in FIG. 3B) in motion is detected. Therefore, the width of the extraction area 201 may be reduced to a value that allows it to correctly detect the leading end of the work 9. This makes it possible to reduce the number of pixels whose pixel data is to be output from the extraction area 201, and thus it is possible to reduce the processing load imposed on the software functioning as the moving object detection unit 5. Furthermore, it becomes possible to transmit the pixel data of the extraction area 201 at a high transmission rate, and thus it is possible to set the detection period of the moving object detection unit 5 to a short period, which makes it possible for the moving object detection unit 5 to accurately detect the position of the work 9.

In most cases where a CCD sensor is used, it is allowed to select pixels only in units of horizontal lines (rows) and thus extraction of pixels is performed in units of horizontal lines. On the other hand, when a CMOS sensor is used, it is generally allowed to extract pixels for an arbitrary area size. Therefore, it is allowed to set the extraction area 201 such that the extraction area 201 does not include an area that is not necessary in detecting the arrival of the work 9 at the preliminary detection position before the predetermined image capture position. An example of such setting of the extraction area 201 is illustrated in FIG. 3C.

In the example illustrated in FIG. 3C, the width (as defined in the vertical direction in FIGS. 3A to 3C) of the extraction area 201 is set to be equal to the width in FIG. 3B, but the horizontal range of the extraction area 201 is set to cover only such an area on a side of the image sensing area 200 from which the work 9 enters the image sensing area 200 in the direction denoted by the arrow 30a. In FIGS. 3A to 3C, the work 9 is drawn so as to be located in the center of the image sensing area 200. This location is, for example, the image capture position at which the image of the work 9 is captured and transmitted to the image processing apparatus 6. In the example illustrated in FIG. 3C, the horizontal length of the extraction area 201 is set so as to cover the almost entire image of the work 9 when the work 9 is located at the image capture position in the center of the image sensing area 200, but the extraction area 201 does not include a work exit area of the image sensing area 200 to the right of the work 9.

As described above with reference to the example illustrated in FIG. 3C, the pixel selection unit 3 is capable of setting the extraction area 201 such that pixel data of pixels located ahead of the image capture position (in an area on the right-hand side in FIG. 3C) is not output because data of the pixels located in such an area is not necessary in detecting the arrival of the work 9 at the image capture position. The setting of the extraction area 201 as illustrated in FIG. 3C makes it possible to further improve the amount of pixel data to be transferred and transfer rate compared with the setting illustrated in FIG. 3B, and thus it is possible to improve the detection period and the detection accuracy in the detection operation performed by the moving object detection unit 5.

Next, an example of a process performed by the moving object detection unit 5 realized by, for example, the CPU 21 by executing software is described below.

FIGS. 4A to 4C illustrate column pixel luminance in the horizontal direction output from pixels from the image sensor 2 at time tl, tm, and tn, respectively, during the work transportation. In these figures, analog image signals of an image captured by the image sensor 2 are output along horizontal five lines (a to e) in the extraction area (201). On the left-hand side of each of FIGS. 4A to 4C, the pixel luminance is represented by shading, and the corresponding luminance is represented in graphs on the right-hand side. Note that the image sensor 2 operates such that scanning is performed line by line in the horizontal direction, and the image sensor 2 is located such that the horizontal scanning direction is parallel to the direction in which the work 9 is transported. The image sensor 2 outputs a luminance value at each pixel location defined by pixel coordinates on each horizontal line (row) (a to e).

In FIGS. 4A to 4C, image data are in order of time tl<tm<tn where tl is older in time and tn is later in time. The image data in FIG. 4A is at time tl when the work 9 reaches an end of the angle of view, while the image data in FIG. 4C is at time tn when the work 9 reaches the particular position close to the image capture position. The image data in FIG. 4B is at time tm between time tl and time tn.

The image data or output information from the image sensor 2 is obtained in the above-described manner according to the present embodiment, and is analyzed by the software of the moving object detection unit 5 to detect the arrival of the work 9 at the preliminary detection position before the predetermined image capture position by a proper method. Some examples of detection methods are described below.

Note that the detection processes described below are performed on the image data of the extraction area 201. In the image data of the extraction area 201, positions (coordinates) of pixels are respectively identified, for example, by two-dimensional addresses of the image memory 22 indicating rows (lines) and columns.

### First Detection Method

1-1) A position where a large change in luminance occurs is detected on a line-by-line basis to detect a position where a moving object is likely to be located.

1-2) From these positions, a position (column position) of a most advanced edge (leading edge) on a line in the work traveling direction is detected, and this edge position is compared with a predetermined edge position of the work 9 located at the optimum position where the work 9 is to be subjected to the measurement.

1-3) In a case where the comparison indicates that the difference is smaller than a predetermined value, it is determined that the work 9 is at the optimum position.

### Second Detection Method

2-1) A position where a large change in luminance occurs is detected on a line-by-line basis to detect a position where a moving object is likely to be located.

2-2) From these positions, a position (column position) of a most advanced edge (leading edge) on a line in the work traveling direction and a position (column position) of an opposite edge (trailing edge) on a line that is most delayed in the work traveling direction are detected, and the center point between them is calculated.

2-3) The position of the center point is compared with a predetermined center position of the work 9 located at the optimum position where the work 9 is to be subjected to the measurement.

2-4) In a case where the comparison indicates that the difference is smaller than a predetermined value, it is determined that the work 9 is at the optimum position.

### Third Detection Method

3-1) In stead of detecting the center point between the leading edge and the trailing edge in the second detection method, a line having a largest edge-to-edge distance between a leading edge and a trailing edge is detected, and a barycenter position of this line is determined. The barycenter position of a horizontal line may be determined from a luminance distribution of image data. More specifically, for example, the barycenter position may be calculated using pixel luminance at an n-th column and its column position n as follows:

Σ((pixel luminance at n-th column)×(column position n))/Σ(pixel luminance at n-th column) (1)

3-2) The barycenter calculated above is compared with a predetermined barycenter of the work 9 located at the optimum position where the work 9 is to be subjected to the measurement.

3-3) In a case where the comparison indicates that the difference is smaller than a predetermined value, it is determined that the work 9 is at the optimum position.

In the detection of the position of the work 9 by the moving object detection unit 5, in order to increase the frequency of detecting the work position to prevent the correct position from being missed, it may be advantageous to minimize the amount of calculation such that the calculation is completed in each image acquisition interval. From this point of view, the three detection methods described above need a relatively small amount of calculation. Besides, it is possible to perform the calculation on a step-by-step basis in synchronization with the horizontal scanning of the image sensor 2. Thus, the three detection methods described above are suitable for detecting the arrival of the work 9 at the preliminary detection position before the predetermined image capture position. It is possible to detect the optimum position substantially in real time during each period in which image data is output from the image sensor 2.

Note that the above-described detection methods employed by the moving object detection unit 5 are merely examples, and details of each method of detecting the image capture position of the work 9 by the moving object detection unit 5 may be appropriately changed. For example, in a case where the CPU 21 used to execute the software of the moving object detection unit 5 has a high image processing capacity, a higher-level correlation calculation such as two-dimensional pattern matching may be performed in real time to detect a particular shape of the work.

According to the present embodiment described above, it is possible to detect the position of a moving object such as the work 9 without using additional elements such as an external sensor or the like, and then capture an image of the work 9 at the optimum position by the image pickup apparatus 1 and finally send the captured image data to the image processing apparatus 6. In particular, in the present embodiment, it is possible to capture images of a moving object or the work 9 for use in detecting the work 9 and for use in the image processing via the same imaging optical system 20 and the same image sensor 2. This makes it possible to very accurately determine the image capture position of the work 9.

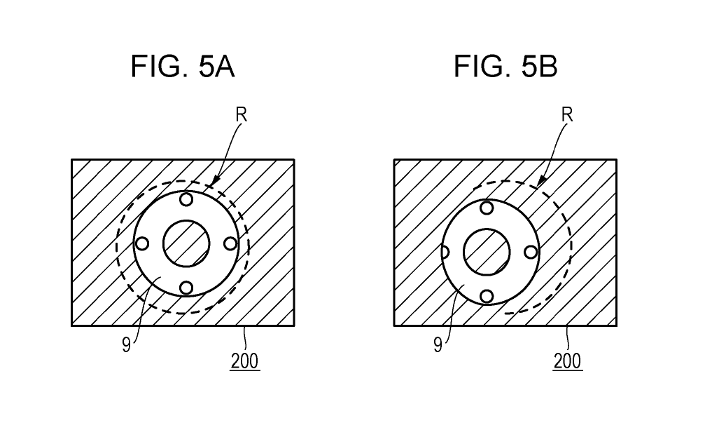

A specific example of an application in which it is necessary to accurately determine the image capture position is an inspection/measurement in which the work 9 is illuminated with spot illumination light emitted from a lighting apparatus (not illustrated) and an image of the work 9 is captured by the image pickup apparatus 1 using regular reflection. FIGS. 5A and 5B illustrate a manner in which the work 9 is illuminated with spot illumination light and an image of the work 9 is captured using the regular reflection by the image pickup apparatus 1 illustrated in FIG. 1. In each of FIGS. 5A and 5B, an area represented by a broken circular line is a regular reflection image sensing area R which is illuminated with circular spot illumination light and in which it is allowed to capture an image of regular reflection component by the image pickup apparatus 1. The circular regular reflection image sensing area R is set at the particular image capture position in front of the imaging optical system 20 such that the center of the regular reflection image sensing area R is substantially on the optical axis of the imaging optical system 20. Furthermore, in each of FIGS. 5A and 5B, a not-hatched area represents the work 9 illuminated with the spot illumination light, and a surrounding hatched area is an area in which there is no object illuminated with spot illumination light. In a captured image, the surrounding hatched area is dark.

In this image capturing method, if the image capture position is deviated even by a small amount from the regular reflection area, a part of the image of the work 9 becomes dark, and it becomes impossible to capture the image of the whole work 9, as illustrated in FIG. 5B. In contrast, in FIG. 5A, the work 9 is located at the particular image capture position within the regular reflection image sensing area R. This makes it possible for the image sensor 2 to capture an image of the work 9 including details thereof, and the captured image data is transmitted to the image processing apparatus 6. However, in the case where the image is captured under the condition such as that illustrated in FIG. 5B, although the whole image of the work 9 is within the angle of view, the details of the work 9 include a part slightly deviated from the regular reflection image sensing area R. This may make it difficult for the image processing apparatus 6 to perform an accurate inspection/measurement.

The present embodiment makes it possible to accurately detect the arrival of the work 9 at the preliminary detection position before the image capture position in any case in which the extraction area 201 is set in one of manners illustrated in FIGS. 3A to 3C. Thus, even in the case where regular reflection image capturing is performed, it is ensured to prevent an image from being captured under such a condition as that illustrated in FIG. 5B.

In some cases, depending on how the hardware configuration is given for the image pickup apparatus 1, there is a possibility that it is necessary to reduce the switching speed at which the pixel selection unit 3 switches the pixel selection mode of the image sensor 2. When this is the case, the size, the location, the number of pixels, and/or the like of the extraction area 201 may be appropriately set such that it becomes possible to increase the image capturing frame rate in detecting the position thereby handling the above situation.

In some cases, in the detection by the moving object detection unit 5 as to the arrival of the work 9 at the preliminary detection position before the predetermined image capture position, it may be important to properly set the distance (as defined, for example, in units of pixels) between the particular position and the image capture position. In the above description, it is assumed that when the moving object detection unit 5 detects the arrival of the work 9 at the preliminary detection position before the predetermined image capture position, then immediately the reading mode of the image sensor 2 is switched, and at the same time the switching of the destination of the image data transmission by the output destination selection unit 4 is performed. In this situation, the preliminary detection position to be detected by the moving object detection unit 5 may be properly set such that the preliminary detection position is located a particular distance before the predetermined image capture position where the particular distance (as defined, for example, in units of pixels) is a distance travelled by the work 9 (the image of the work 9) during a period in which the reading mode is switched and the image data transmission destination is switched. In this setting, for example, the particular distance before the predetermined image capture position may include a margin taking into account a possibility of further delaying in switching the reading mode and switching the image data transmission destination for some reason. Conversely, in a case where the circuit delay or the like is small enough, the particular distance before the predetermined image capture position may be set to zero, and the moving object detection unit 5 may directly detect the image capture position. As described above, the particular distance between the preliminary detection position to be detected by the moving object detection unit 5 and the predetermined image capture position may be set appropriately depending on the circuit delay time and/or other factors or specifications of the system. On the other hand, in applications in which it is necessary to more accurately control the image capture position as in inspection/measurement, the distance between the preliminary detection position and the predetermined image capture position may include a further margin in addition to the distance travelled by the work 9 (the image of the work 9) during the period in which the reading mode is switched and the image data transmission destination is switched. Furthermore, in such applications in which it is necessary to accurately control the image capture position, the extraction area 201 in which the moving object is detected may be set to have a margin so as to cover a sufficiently long approaching path before the predetermined image capture position. The setting of the preliminary detection position to be detected by the moving object detection unit 5 or the setting of the coverage range of the extraction area 201 may be performed depending on the traveling speed of the work 9 and/or the switching time necessary for the circuit to switch the reading mode and the image data transmission destination.

In the control procedure illustrated in FIG. 2, in a case where only one type of work is handled, instead of returning from procedure S6 to procedure S1 in FIG. 2, the flow may be returned directly to procedure S3. By changing the mode of the control procedure as described above, it becomes unnecessary to switch the pixel selection mode in the state in which the process waits for the work 9 to arrive, for example, in a case where only one type of work is transported at a high speed, and thus it becomes possible to perform a high-speed sequence, which results in an improvement in throughput.

According to the present embodiment, as described above, it is possible to automatically capture an image of a work at an optimum image capture position and transmit resultant image data to the image processing apparatus at a high speed and with high reliability without stopping the motion of the work or an object, without needing an additional measurement apparatus other than the image pickup apparatus. Furthermore, unlike the conventional technique in which detection of the position of the work is performed via image processing by an image processing apparatus, the detection of the position of the work according to the present embodiment is achieved by using the small extraction area 201 and controlling the image data outputting operation of the image sensor 2 of the image pickup apparatus 1. Thus the present embodiment provides advantageous effects that it is possible to achieve a great improvement in processing efficiency in image processing, controlling the posture (phase) of the work and controlling the transportation of the work based on the image processing, inspecting the work as a product, and the like.

### Second Embodiment

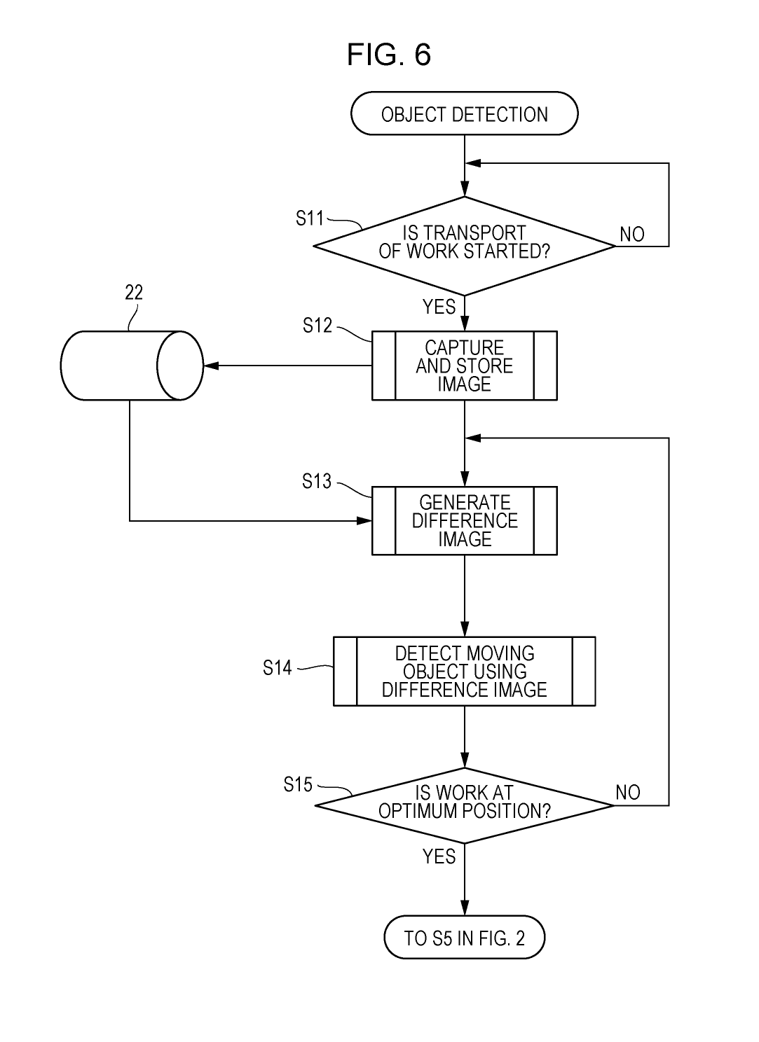

FIG. 6 illustrates an image capture control procedure according to a second embodiment. In this embodiment, an image subtraction processing is performed and a moving object detection process is performed based on a generated difference image.

The processing flow illustrated in FIG. 6 illustrates a process that replaces a first half of the flow chart illustrated in FIG. 2. To execute the image capture control procedure according to the present embodiment, a hardware configuration similar to that illustrated in FIG. 1 according to the first embodiment may be used. Therefore, hereinafter, similar elements or similar functional blocks to those according to the first embodiment are referred to similar reference numerals. The control procedure illustrated in FIG. 6 may be described, for example, in the form of a control program executable by the CPU 21 of the image pickup apparatus 1 and may be stored in the ROM 23 or the like as in the first embodiment.

In step S11, the CPU 21 determines whether a work transportation start signal has been received from the sequence control apparatus 7. In a case where transporting of a work is not yet started, the processing flow remains in step S11 to wait for conveying of a work to start.

In step S12, immediately after transporting of a work is started, an image is captured in a state in which the work 9 (and the robot arm 8 holding the work 9) is not yet in the angle of view of the image pickup apparatus 1, and the obtained image data is stored as a reference image in a particular memory space of the image memory 22. In this state, an output area of the image sensor 2 selected by the pixel selection unit 3 may be given by, for example, one of the extraction areas 201 illustrated in FIGS. 3A to 3C. In this case, image data of the extraction area 201 is stored as the reference image in the image memory 22.

In the above-described process in step S12, the image data of the whole image sensing area 200 of the image sensor 2 may be stored as the reference image in the image memory 22 or image data of only an area with a particular size and at a particular location to be transmitted to the image processing apparatus 6 may be stored. However, in the moving object detection process performed by the moving object detection unit 5 in steps S13 to S15 described below, only the image data of the extraction area 201 is necessary as with the first embodiment, and thus it is sufficient to store only the image data of the extraction area 201 as the reference image.

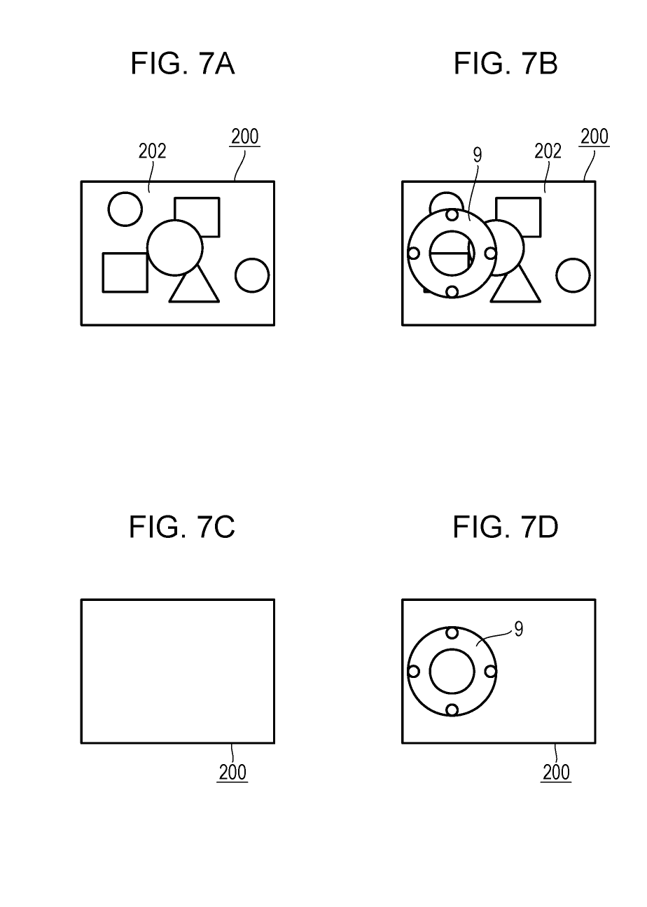

FIGS. 7A to 7D illustrate examples of images captured by the image sensor 2 according to the present embodiment. In FIGS. 7A to 7D, for ease of understanding, the extraction area 201 is not intentionally shown but the image of the whole image sensing area 200 of the image sensor 2 is illustrated.

FIG. 7A illustrates an example of a reference image, to be stored in the image memory 22 in step S11, captured in a state in which the work 9 has not yet arrived. In this example, the captured image includes a background image (schematically represented by a circle, a rectangle, a triangle, and the like) of the transport space 30. When the work 9 enters the angle of view of the image sensor 2, an image of the work 9 is captured as illustrated in FIG. 7B. However, this image includes the unwanted background which may cause a recognition error to occur in the moving object detection, which may result in an error in the detection of the position of the work 9.

To handle the above situation, an image subtraction processing is performed to obtain a difference image between the reference image illustrated in FIG. 7A and the image including the incoming work 9 illustrated in FIG. 7B, for example, by subtracting pixel values (for example, luminance values) between corresponding pixels on a pixel-by-pixel basis. As a result of the image subtraction processing, it is possible to obtain a difference image such as that illustrating in FIG. 7D including only image information of the work 9 that exists only in the image in FIG. 7B. Note that the background exits in both images in FIGS. 7A and 7B, and if an image is captured in a state in which the work 9 has not yet entered the angle of view of the image sensor 2, a resultant image is essentially the same as that in FIG. 7A. Therefore, if the difference between this image and the image in FIG. 7A is calculated, the result is an image in which the image information of the background is completely cancelled as illustrated in FIG. 7C. By performing the above-described image subtraction processing before the moving object detection process, it is possible to remove image information of the background or the like which may disturb the moving object detection process. Thus it is possible to reduce the probability of error recognition in the moving object detection, which makes it possible to more accurately detect the arrival of the work 9 at the preliminary detection position before the image capture position.

The image subtraction processing described above briefly is performed in step S13 in FIG. 6. In step S13, first, image data of an image newly captured by the image sensor 2 is read out in the state in which the extraction area 201 set by the pixel selection unit 3 is maintained the same as for the reference image. Next, a difference image is generated by calculating a difference between the reference image with the size corresponding to the extraction area 201 stored in the image memory 22 and the image data newly read from the image sensor 2 for the same extraction area 201. More specifically, the generation of the difference image may be performed by calculating a difference between a pixel value (for example, a luminance value) at a pixel addresses of the reference image and a pixel value at a corresponding pixel addresses of the image data newly read out from the image sensor 2 and stored in the image memory 22 on a pixel-by-pixel basis for all necessary pixels. The image subtraction processing described above is a simple subtraction operation, and thus it is possible to execute the image subtraction processing at a high speed with low cost. The generated difference image is stored in a particular memory space of the image memory 22 allocated in advance for the difference image.

Next, in step S14, the moving object detection unit 5 performs the moving object detection process based on the difference image generated in step S13. The moving object detection process may be performed in a similar manner to the first embodiment described above. The difference image is generated for the size defined by the extraction area 201 set by the pixel selection unit 3, and thus it is possible to execute the process at an extremely high speed as described in the first embodiment.

Next, step S15 corresponding to step S4 in FIG. 2 is performed to determine whether the work 9 detected in step S14 is located at the predetermined image capture position. In a case where the difference between the current position of the work 9 and the predetermined image capture position is greater than a predetermined value, the processing flow returns to step S13. In step S13, an image data of the extraction area 201 is newly acquired from the image sensor 2 and a difference image is generated using this newly acquired image data.

On the other hand, in a case where the difference between the current position of the work 9 and the predetermined image capture position is equal to or smaller than the predetermined value, it is determined in step S15 that the work 9 is located at the optimum position. In this case, the processing flow proceeds to step S5 in FIG. 2. In step S5, as described in the first embodiment, the output mode of the image sensor 2 is switched to a mode in which pixel data is output from the pixel region corresponding to the particular image size necessary in the image processing performed by the image processing apparatus 6. Furthermore, the interface circuit 25 of the output destination selection unit 4 is controlled such that the destination of the output of the image sensor 2 is switched to the image processing apparatus 6. Next, in step S6 in FIG. 2, the image data of the pixel region corresponding to the particular image size necessary in the image processing is transmitted to the image processing apparatus 6.

As described above, even in a circumstance in which the extraction area 201 set by the pixel selection unit 3 includes an image of unwanted structure or a background, it is possible to remove such noise information that may disturb the moving object detection before the moving object detection process is performed. In the case where only the control operation according to the first embodiment is performed, it is necessary to adjust the depth of field such that the image is focused only on the work and adjust the illumination such the background is not captured in the image. However, such considerations are not necessary in the case where the image subtraction processing is performed according to the second embodiment, and it is possible to detect the position of the work 9 with high accuracy and high reliability. Furthermore, an image of the work 9 is captured at the optimum position by the image pickup apparatus 1, and the captured image data is sent to the image processing apparatus 6.

In the above description, it is assumed that in step S12, the image captured immediately after the transporting of the work 9 is started is employed as the reference image. By acquiring the reference image each time the transporting of the work 9 is started, it is possible to minimize the influence of a time-dependent change and/or an environmental change in terms of illumination condition, a mechanism layout, or the like, which makes it possible to remove the disturbance information caused by the background behind the work 9. However, in a case where the influence of a time-dependent change and/or an environmental change is small in terms of the condition of illumination the whole apparatus, a mechanism layout, or the like, the acquisition of the reference image in step S12 may be performed in an off-line mode separately from the actual production operation. When the operation including handling the work 9 is performed in the production line, the reference image captured in advance may be used continuously. In this case, the acquisition of the reference image in step S12 may be performed again in a particular situation such as when initialization is performed after the main power of the production line is turned on.

The above-described method, in which the reference image is acquired in an offline state other than in a state in which a production line is operated, may be advantageously used in an environment in which the work 9 or the transport unit such as the robot arm 8 is inevitably included in a part of the angle of view of the image pickup apparatus 1 in the online state, which may make it difficult to acquire the reference image in the online state. However, by acquiring the reference image in the offline state, it becomes possible to surely acquire a reference image necessary in the present embodiment, which makes it possible to detect the position of the work 9 with higher accuracy and higher reliability.

### Third Embodiment

A third embodiment described below discloses a technique in which an area of an image to be transmitted to the image processing apparatus 6 is determined via a process, or using a result of the process, that is performed by moving object detection unit 5 to determine a moving object in a state in which the extraction area 201 is specified by the pixel selection unit 3.

Also in this third embodiment, as with the first and second embodiments, a hardware configuration similar to that illustrated in FIG. 1 may be used. The present embodiment is useful in particular when the image sensor 2 is of a type, such as a CMOS sensor, having a capability of specifying an output mode in which image data is output for a partial image area including only particular rows and columns.

Note that the process of detecting the moving object by the moving object detection unit 5 in a state in which the extraction area 201 is specified by the pixel selection unit 3 is similar to the process according to the first embodiment described above with reference to FIG. 2 or the second embodiment described above with reference to FIG. 6.

A step of determining the area of the image to be transmitted to the image processing apparatus 6 according to the present embodiment corresponds to step S5 in FIG. 2. In this step, in the first and second embodiments, when the image data is transmitted to the image processing apparatus 6, the pixel selection unit 3 switches the area of the image to a transfer area corresponding to the predetermined output format, and the image data is output in this format to the image processing apparatus 6. In contrast, in the present embodiment, the area of the image to be transmitted to the image processing apparatus 6 is determined via the process or the result of the process as to the detection of the moving object by the moving object detection unit 5 in a state in which the extraction area 201 is specified by the pixel selection unit 3.

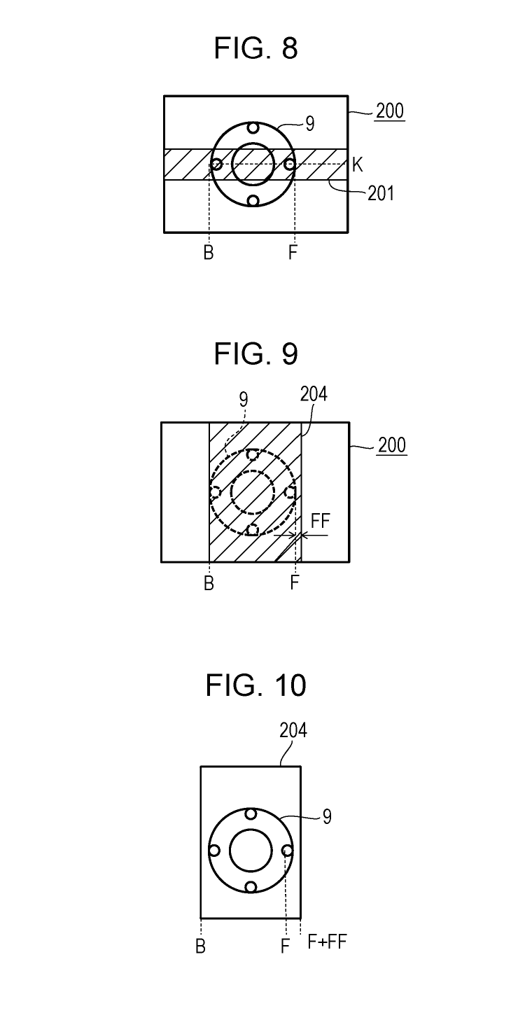

Referring to FIG. 8 and other figures elsewhere, a method of determining the area of the image transmitted to the image processing apparatus 6 according to the present embodiment is described below.

FIG. 8 illustrates an image of the work 9 formed on the image sensor 2 at a point of time when the arrival of the work 9 at the preliminary detection position before the predetermined image capture position is detected using the method according to the first or second embodiment, that is, at a point of time immediately before the pixel selection unit 3 switches the image readout area. In FIG. 8, F denotes a position of a leading end of the work 9, that is, a column position of a right most point, as seen in the traveling direction, of the work 9, B denotes a leftmost point at a trailing end of the work 9, and K denotes a position of a row (line) on which the leading end point F and the trailing end point B are detected on the image. Note that these positions F, B, and K may be defined, for example, by coordinates on the image memory 22, and may be expressed in units of pixels in the row (line) direction and the in the column direction.

In the present example, it is assumed that the extraction area 201 shaded with slanted lines is specified by the pixel selection unit 3 as the readout area of the image sensor 2 from which to read out the image data for use in the detecting a moving object. In the present embodiment, the area of an image to be extracted and transmitted to the image processing apparatus 6 is determined using the extraction area setting described above.

FIG. 9 illustrates an example of a transfer area 204 defining an area of an image to be extracted and transmitted to the image processing apparatus 6. The example illustrated in FIG. 9 indicates a simplest manner in which the leading column position (F) and the trailing column position (B) detected in the moving object detection process are used. That is, the pixel selection unit 3 defines a transfer area 204 as an area from the column B to a column F+FF thereby specifying the area of the image to be output from the image sensor 2 and transfers the image data in this area (shaded with slanted lines in FIGS. 9) to the image processing apparatus 6.

In FIG. 9, FF denotes a margin added to the column address F taken into account a movement of the work 9. More specifically, for example, the margin FF is determined so as to have a value corresponding to a width across which the work 9 (broken line) is predicted to move in a time period δt taken by the pixel selection unit 3 to switch the output area. The margin FF may be determined in advance based on the predicted speed of the work 9. Alternatively, the actual moving speed of the work 9 may be measured, for example, based on a clock signal used in accessing of the image sensor 2. More specifically, for example, the moving speed of the work 9 may be calculated from the position of the leading end of the work 9 detected at a particular timing in detecting the moving object in the extraction area 201, the position of the leading end detected at an immediately previous timing, and time information based on the clock signal.

By setting the transfer area 204 so as to have a margin with a pixel width of FF at a side corresponding to the leading end of the work 9 entering the image sensing area based on the work speed and the time δt necessary to switch the output area of the pixel selection unit 3 as described above, it becomes possible to surely catch the work 9 in the transfer area 204. More specifically, when F′ and B′ respectively denotes the leading column position and the trailing column position detected, in the extraction, δt seconds after the detection of the column position of the leading end (F) and the column position of the trailing end (B) of the work 9, then

F′<F+FF and B′>B (2)

F and B indicate pixel positions acquired based on the detection information of the leading end and the trailing end of the work 9 detected in the moving object detection, and thus the transfer area 204 includes substantially only image information of the work 9 in the direction of the line width as illustrated in FIG. 10. By transmitting only the image data in this transfer area 204 specified by the pixel selection unit 3 to the image processing apparatus 6 from the image sensor 2, it is possible to achieve a great improvement in the transmission efficiency of the image data.

By controlling the transmission operation in the above-described manner, it is possible to transmit to the image processing apparatus 6 the image data including only the work 9 extracted in the line direction within the width from the column B to the column F+FF as illustrated in FIG . 10 (or FIG. 9) thereby providing the information necessary in analyzing the image of the work 9. Thus even in a case where the image sensor 2 used is low in switching the output area or the resolution or in outputting pixel data, it is possible to efficiently extract the image and transmit it to the image processing apparatus 6. On the other hand, in a case where the image sensor 2 used is capable of switching the extraction area or the resolution at a sufficiently high speed with respect to the moving speed of the work 9, it is possible to set the above-described margin width FF to a small value. In a case where a high-performance image sensor is used or in a case where the moving peed of the work 9 is relative low, or depending on other factors, it is possible to set the margin width FF to 0 or one pixel.

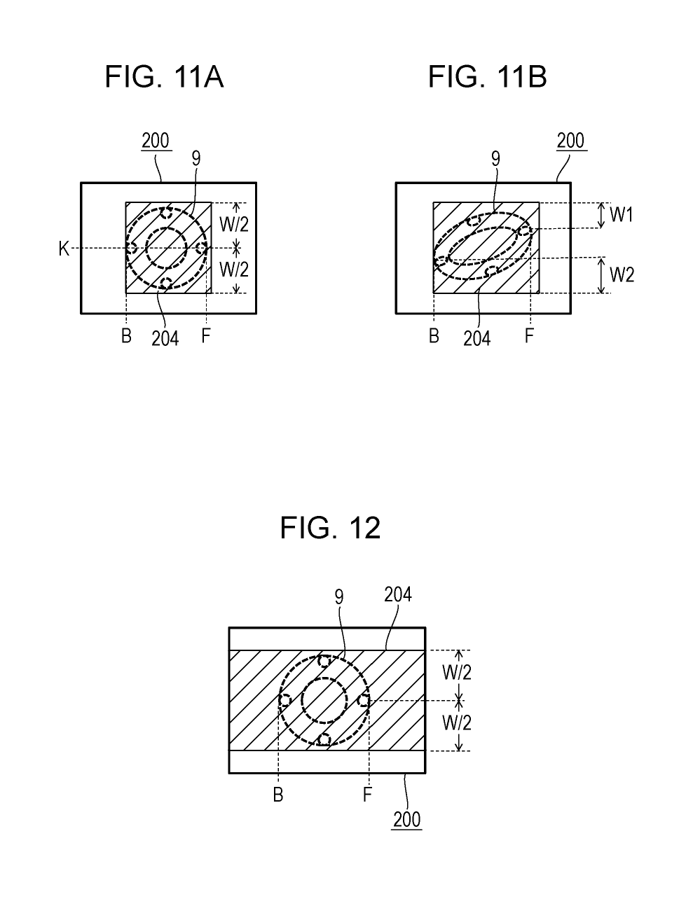

FIGS. 11A and 11B illustrate examples in which the transfer area 204 defining the area of the image to be transmitted to the image processing apparatus 6 is set such that a further restriction is imposed on the row direction thereby further reducing the size thereof.

In FIG. 11A, W (W/2+W/2) denotes the number of lines (rows) on the image determined such that the height of the image of the work 9 is included in this height W. Note that W (W/2+W/2) is set to be equal to the maximum possible height of the image of the work 9 plus a properly determined margin. The maximum possible height of the image of the work 9 is estimated based on the actual size of the work 9, the magnification of the imaging optical system 20, and the like, and the margin is determined taking into account certainty caused by varieties of the size, the magnification, and the like, and errors in capturing the image. In a specific case in which the work 9 is cylindrical in outer shape and it is known that the height and the width are equal in the image thereof as illustrated in FIG. 11A, the value of W (or W/2) may be determined based on the distance between positions F and B detected in the moving object detection. The value W defining the number of rows (lines) to be transmitted may be specified by the pixel selection unit 3 by specifying the transfer area such that when the position of the leading end of the work detected in the moving object detection is represented by coordinates (F, K), the image is extracted over a vertical range from line K −W/2 to line K+W/2 with respect to line K.

The positions F and B are determined using the position information of the leading end and the trailing end of the work 9 detected in the moving object detection in a similar manner as described above with reference to FIGS. 8 and 9. By setting the transfer area 204 using the pixel selection unit 3 as illustrated in FIG. 11A and transmitting the image data in the transfer area 204 from the image sensor 2 to the image processing apparatus 6, it is possible to further improve the transmission efficiency of the image data to the image processing apparatus 6 compared to the examples illustrated in FIGS. 9 and 10.

In a case where the work is asymmetric in shape in the vertical direction or in a case where it is known in advance that the image of the work is captured in a state in which the work rotates within a phase range in the image, the height of the transfer area 204 may be determined as illustrated in FIG. 11B. In FIG. 11B, W1 denotes the number of rows (lines) included in a vertical range from a line on which the detected leading end (with the column position F) of the work 9 lies to a line on which an estimated possible uppermost edge of the image of the work 9 lies, while W2 denotes the number of rows (lines) included in a vertical range from a line on which the detected trailing end (with the column position B) of the work 9 lies to a line on which an estimated possible lowest edge of the image of the work 9 lies. The values of W1 and W2 may be determined based on the actual size of the work 9, the magnification of the imaging optical system 20, the phase of the work 9 of the captured image of the work 9, and the like, and taking into account certainty caused by varieties of the above factors and errors in capturing the image. After the values of W1 and W2 are determined, an upper line is determined that is apart upward by W1 from the line on which the leading end (with the column position F) of the work 9 is detected, and a lower line is determined that is apart downward by W2 from the line on which the trailing end (with the column position B) of the work 9 is detected. The height of the transfer area 204 is then defined by the determined range from the upper line and the lower line.

The positions F and B may be determined using the position information of the leading end and the trailing end of the work 9 detected in the moving object detection as described above. As described above, using the position information of the work 9 at the point of time when the arrival of the work 9 at the preliminary detection position before the image capture position in the moving object detection, the pixel selection unit 3 sets the transfer area 204 as illustrated in FIG. 11B. The image data in this transfer area 204 is then transmitted from the image sensor 2 to the image processing apparatus 6. Thus, it is possible to achieve an extreme improvement in efficiency of transmission to the image processing apparatus 6.

In a case where in FIG. 11B, the actual phase (posture) of the work 9 at the point of time when the image is captured is not known, the number of lines W1 and W2 may be determined based on estimation of the phase (posture) of the work 9. The phase (posture) of the work 9 may be estimated, for example, based on the distance (the number of lines) between the lines on which the leading end (F) and the trailing end (B) of the work 9 are respectively detected. The values W1 and W2 may be roughly determined in advance. A multiplier may be determined depending on the distance (the number of lines) between the lines on which the leading end (F) and the trailing end (B) of the work 9 are respectively detected, and the roughly-determined values W1 and W2 may be multiplied by the determined multiplier for adjustment.

In a case where the image sensor 2 used does not have a capability of extracting the image in a range between different columns, but extraction is allowed only for a range between lines as is with many CCD sensors, the pixel selection unit 3 may set the transfer area 204 as illustrated in FIG. 12. In FIG. 12, the transfer area 204 (shaded with slanted lines) is set so as to output lines in a vertical range with a height equal to W corresponding to the height of the work 9 (in a range whose upper limit is W/2 apart upward and whose lower limit is W/2 apart downward from the line on which the leading end and the trailing end of the work 9 are detected) described above with reference to FIG. 11A. Thus also in the case where the capability of the image sensor 2 used allows it specify the output area only in a vertical range between lines, it is possible to improve the efficiency of transmission to the image processing apparatus 6 by performing the setting of the output area of the transfer area 204 as described above.

According to the present embodiment, as described above, using the position information of the work 9 at the point of time when the arrival of the work 9 at the preliminary detection position before the image capture position is detected in the moving object detection, the pixel selection unit 3 sets the transfer area 204 indicating the area of the image data to be transmitted to the image processing apparatus 6. By transmitting the image data in this transfer area 204 from the image sensor 2 to the image processing apparatus 6, it is possible to achieve a great improvement in efficiency of transmission to the image processing apparatus 6. According to the present embodiment, it is possible to reduce the amount of image data transmitted to the image processing apparatus 6, and thus even in a case where the interface circuit 25 used does not have high communication performance, it is possible to achieve a small overall delay in the image processing. Thus, the present embodiment provides an advantageous effect that it is possible to control the posture or inspect the work 9 at a high speed and with high reliability using the image processing by the image processing apparatus 6.

The present invention has been described above with reference to the three embodiments. Note that the controlling of the image capturing process according to the present invention may be advantageously applied to a production system in which a robot apparatus or the like is used as a transport unit, an image of an object such as a work is captured while moving the object, and the production process is controlled based on the image processing on the captured image. Note that the controlling of the image capturing process according to any one of the embodiments may be performed by the CPU 21 of the image pickup apparatus by executing software of an image capture control program, and the program that realizes control functions according to the present invention may be stored in advance, for example, in the ROM 23 as described above. The image capture control program for executing the present invention may be stored in any type of computer-readable storage medium. Instead of storing the program according to the program in advance in the ROM 23, the program may be supplied to the image pickup apparatus 1 via a computer-readable storage medium. Examples of computer-readable storage media for use in supplying the program include various kinds of flash memory devices, a removable HDD or SSD, an optical disk, or other types of external storage devices. In any case, the image capture control program read from the computer-readable storage medium realizes the functions disclosed in the embodiments described above, and thus the program and the storage medium on which the program is stored fall within the scope of the present invention.

In the embodiments described above, it assumed by way of example but not limitation that the robot arm is used as the work transport unit. Note that also in a case where another type of transport unit such as a belt conveyor or the like is used as the work transport unit, it is possible to realize the hardware configuration and perform the image capture control in a similar manner as described above.

According to the present embodiment, as described above, it is possible to automatically capture an image of a moving object at an optimum image capture position at a high speed and with high reliability without stopping the motion of the moving object and without needing an additional measurement apparatus other than the image pickup apparatus. The image capture position at which to capture the image of the moving object is detected based on a pixel value in the extraction area wherein the extraction area has a smaller image size or a smaller pixel density than the image size or the pixel density of the output format and wherein the extraction area is located on such a side of the image sensing area of the image sensor from which the image of the moving object is to approach the image sensing area thereby making it possible to detect the position of the moving object at a high speed using only necessary pixels.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-097507, filed May 9, 2014, which is hereby incorporated by reference herein in its entirety.

What is claimed is:

1. An image capturing control method for capturing an image of a moving object using an image sensor and outputting image data in an output format with a predetermined image size and pixel density from the image sensor, the method comprising:
setting, by a control apparatus, an output mode of the image sensor to a first output mode in which image data of an extraction area is output wherein the extraction area has a smaller image size or a smaller pixel density than the image size or the pixel density in the output format and wherein the extraction area is located on such a side of an image sensing area of the image sensor from which the image of the moving object is to approach the image sensing area;
performing a moving object detection process by the control apparatus to detect whether a position of the moving object has reached a preliminary detection position before a predetermined image capture position based on a pixel value of the image data output in a state in which the output mode of the image sensor is set in the first output mode; and
in a case where, in the moving object detection process, it is detected that the position of the moving object whose image being captured has reached the preliminary detection position before the image capture position, setting, by the control apparatus, the output mode of the image sensor to a second output mode in which image data captured by the image sensor is output in the output format,
wherein the image data of the moving object captured at the image capture position by the image sensor is output in the second output mode from the image sensor.

2. The image capturing control method according to claim 1, wherein in the moving object detection process, the control apparatus detects the arrival of the moving object at the preliminary detection position before the image capture position based on a change in a luminance value of the image data in a row direction in the extraction area.

3. The image capturing control method according to claim 1, wherein, in the moving object detection process, the control apparatus detects arrival of the moving object at the preliminary detection position before the image capture position based on a barycenter position detected via a luminance distribution of the image data in the extraction area.

4. The image capturing control method according to claim 1, wherein
the control apparatus generates a difference image between image data of a reference image and the image data in the extraction area output from the image sensor in a state in which the output mode of the image sensor is set in the first output mode, wherein the reference image is acquired in advance by capturing an image in the image sensing area before the image of the moving object enters the image sensing area in a state in which the output mode of the image sensor is set in the first output mode, and
in the moving object detection process, the control apparatus performs the detection based on a pixel value of the difference image as to whether the position of the moving object being captured in the extraction area has arrived at the predetermined image capture position.

5. The image capturing control method according to claim 1, wherein when in the moving object detection process the control apparatus detects that the position of the moving object whose image is being captured in the extraction area has arrived at the image capture position, the control apparatus determines the output format in which the image data of the moving object captured at the image capture position is to be output, based on the image data of the moving object captured in the extraction area by the image sensor.

6. An image capturing control program configured to cause the control apparatus to execute the image capturing control method according to claim 1.

7. A computer-readable storage medium storing the image capturing control program according to claim 6.

8. A production method comprising:
capturing an image of a work transported as the moving object using the image capturing control method according to claim 1; and
performing a production process or an inspection process on the work based on the image processing on the image data output from the image sensor in the second output mode.

9. An image pickup apparatus comprising:
a control apparatus configured to control a process of capturing an image of a moving object using an image sensor and outputting image data in an output format with a predetermined image size and pixel density from the image sensor,
the control apparatus being configured to
set an output mode of the image sensor to a first output mode in which image data of an extraction area is output wherein the extraction area has a smaller image size or a smaller pixel density than the image size or the pixel density of the output format and wherein the extraction area is located on such a side of an image sensing area of the image sensor from which the image of the moving object is to approach the image sensing area;
detect whether the position of the moving object has reached a preliminary detection position before a predetermined image capture position based on a pixel value of the image data output in a state in which the output mode of the image sensor is set in the first output mode; and
in a case where it is detected that the position of the moving object has reached the preliminary detection position before the image capture position, set the output mode of the image sensor to a second output mode in which image data captured by the image sensor is output in the output format,
wherein the image data of the image of the moving object captured at the image capture position by the image sensor is output in the second output mode from the image sensor.
